(19) United States
(12) Patent Application Publication
(10) Pub. No.: US 2014/0193787 A1
(43) Pub. Date: Jul. 10, 2014

(54) READING INCENTIVE SYSTEM

(71) Applicant: Michael Marcewicz, Lakeland, FL (US)

(72) Inventor: Michael Marcewicz, Lakeland, FL (US)

(21) Appl. No.: 13/737,946

(22) Filed: Jan. 10, 2013

(51) Int. Cl. G09B 19/00

(52) U.S. Cl. CPC G09B 19/00
USPC 434/236

(57) ABSTRACT

Methods, systems and computer readable media for providing a reading incentive system to encourage reading in children and/or adults are described.

### TECHNICAL FIELD

Embodiments relate generally to electronic reading, and more particularly, to methods, systems and computer readable media for incentivizing reading.

### BACKGROUND

Literacy rates and student preparedness in some countries, such as the U.S., may be in decline. At the same time, the use of portable electronic devices (e.g., electronic book readers, smart phones and the like) is increasing. There may be a need to combine the popularity of or portable electronic devices with a system to encourage more reading, both in children and adults.

Embodiments were conceived in light of the above-mentioned problems and limitations, among other things.

### SUMMARY

Some implementations can include a computer implemented method. The method can include receiving, at a computer configured to execute a reading incentive application, a book selection from a user, and providing, from the computer, an electronic copy of the book to the user. The method can also include starting, at the computer, a first timer, and receiving, at the computer, an indication from the user that the user has completed reading the book within a first time limit as indicated by an elapsed time of the first timer. The method can further include generating a quiz having questions related to the book, and presenting the quiz for display to the user.

The method can include starting a second timer, and receiving answers to the quiz from the user within a second time limit as indicated by an elapsed time of the second timer. The method can also include determining if the user passed the quiz. If the user passed the quiz, a system can credit a number of points to an account associated with the user. If the user did not pass the quiz, the system can present a plurality of user interface elements, wherein one of the user interface elements corresponds to retaking the quiz and another of the user interface elements corresponds to selecting a new book.

The method can also include establishing a new account for the user, the new account including a user profile, authentication credentials and a point balance value. The method can further include permitting the user to access the reading incentive application when the user supplies credentials matching the authentication credentials in an account.

The method can also include providing a user interface adapted to permit the user to redeem points from the point balance value of the account associated with the user. The crediting of a number of points can include determining if the book is indicated as a bonus point book for the user and, when the book is determined to be a bonus point book, crediting an additional amount of points as a bonus to the point balance value of the account associated with the user. The method can also include crediting another point value to an account associated with a third party different from the user when the user passes the quiz.

Some implementations can include a system having a processor and a computer readable medium coupled to the processor, the computer readable medium containing software instructions for a reading incentive application that, when executed by the processor, cause the processor to perform operations. Some implementations can include a nontransitory computer readable medium having stored therein software instructions for a reading incentive application that, when executed by a processor, cause the processor to perform operations.

For either of the implementations mentioned above, the operations can include receiving a book selection from a user and providing an electronic copy of the book to the user. The operations can further include starting a first timer and receiving an indication from the user that the user has completed reading the book within a first time limit as indicated by an elapsed time of the first timer. The operations can also include generating a quiz having questions related to the book and presenting the quiz for display to the user.

The operations can include starting a second timer and receiving answers to the quiz from the user within a second time limit as indicated by an elapsed time of the second timer and determining if the user passed the quiz. If the user passed the quiz, a system or processor can credit a number of points to an account associated with the user. If the user did not pass the quiz, the system or processor can present a plurality of user interface elements, wherein one of the user interface elements corresponds to retaking the quiz and another of the user interface elements corresponds to selecting a new book.

The operations can further comprise establishing a new account for the user, the new account including a user profile, authentication credentials and a point balance value. The operations can also comprise permitting the user to access the reading incentive application when the user supplies credentials matching the authentication credentials in an account. The operations can comprise providing a user interface adapted to permit the user to redeem points from the point balance value of the account associated with the user.

Crediting a number of points can include determining if the book is indicated as a bonus point book for the user and, when the book is determined to be a bonus point book, crediting an additional amount of points as a bonus to the point balance value of the account associated with the user. The operations can further comprise crediting another point value to an account associated with a third party different from the user when the user passes the quiz.

### BRIEF DESCRIPTION OF THE DRAWINGS

FIG. 1 is a flowchart of an example reading incentive method in accordance with at least one embodiment.

FIG. 2 is a flowchart of an example method for awarding points for reading in accordance with at least one embodiment.

FIG. 3 is a diagram of an example computer system in accordance with at least one embodiment.

FIG. 4 is a flowchart of an example method for awarding points for reading in accordance with at least one embodiment.

### DETAILED DESCRIPTION

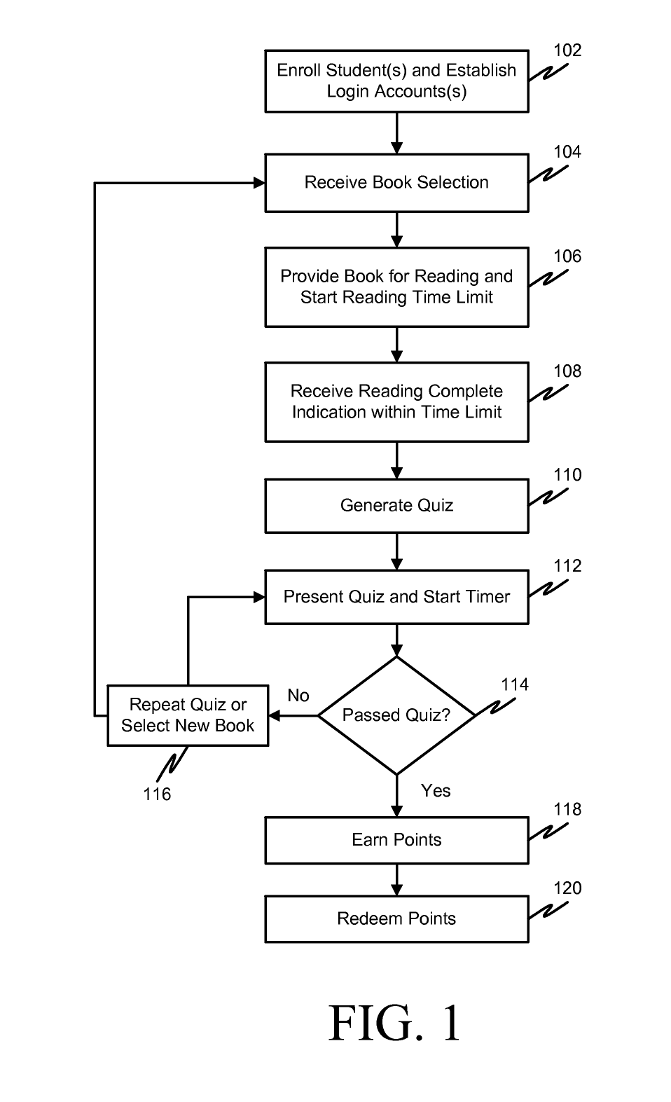

FIG. 1 is a flowchart of an example reading incentive method in accordance with at least one embodiment. Processing beings at 102, where one or more users (e.g., students or adults) enroll and establish a login account. The account can include a user profile with biographical information, authentication credentials (e.g., a user name and password) and an account point balance value. Processing continues to 104.

At 104, the system receives a book selection from a user (once the user has successfully logged into the system). Books can be chosen from a group of available books provided based on reading level, area of interest, or the like. Or, the user can select a book from the entire list of available books. Processing continues to 106.

At 106, the selected book is provided to the user for reading and a first timer is started. The first timer is measuring the duration of time for reading the book. Based on the user's profile information (e.g., age, grade level, or the like) and/or book information (e.g., factors such as length, difficulty or the like), the system can establish a time limit for reading the selected book. In addition to a standard timer, an accelerated reader timer and a challenged reader timer may be used, where the accelerated reader timer provides less time to read a book and the challenged reader timer provides more time. Processing continues to 108.

At 108, the system receives an indication that the user has completed the book within the time limit determined at 106. If the user has not completed the selected book within the time limit determined at 106, the system can notify the user. Optionally, a warning period can be established in which the user has a certain amount of time to complete the book after the warning. If the user has completed the reading within the time limit, then processing continues to 110.

At 110, the system generates a quiz for the user to test knowledge and/or comprehension of the selected book. The quiz is based on the content of the book and can be generated by selecting a predetermined quiz from among a group of one or more quizzes, or by randomly generating a quiz having a predetermined number of questions selected from a group of questions. Processing continues to 112.

At 112, the system presents the quiz to the user and starts a second timer. The second timer is used to measure the duration of time that the user is taking to complete the quiz. Processing continues to 114.

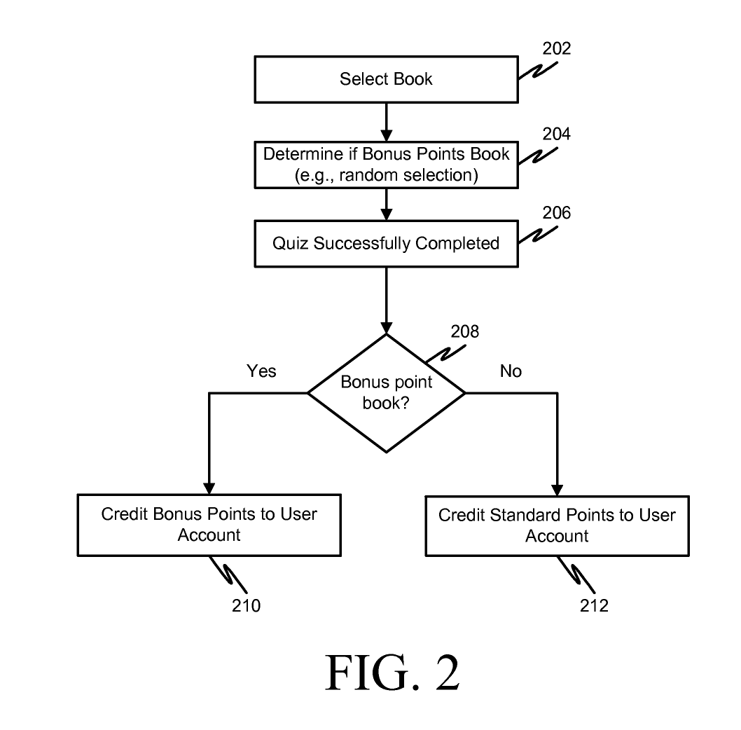

At 114, the system receives the user's quiz answer's and determines if the user passed the quiz. There are two components required to pass the quiz: a predetermined percentage of correct answers and completion within the time limit. If both criteria are met, then the user earns points for reading the book 118 (the book may be a bonus point book in which the user earns bonus points, see FIG. 2 and corresponding description below). If both criteria for passing the quiz are not met, then the user is presented with options (116) to either retake the quiz in which case processing continues to 110 or to select a new book in which case processing continues to 104.

At 120, the user can redeem earned points for one or more rewards such as t-shirts, games, toys, electronics and the like. The system can help encourage reading by providing an incentive (e.g., the reward) for reading books and passing the quizzes for those books.

It will be appreciated that 102-120 can be repeated in whole or in part in order to accomplish a contemplated reading incentive task.

FIG. 2 is a flowchart of an example method for awarding points for reading in accordance with at least one embodiment. Processing begins at 202, where the system receives an indication that a book has been selected by a user. Processing continues to 204.

At 204, the system determines if the book is a bonus point book for this user. For example, the system can use a random selection or a probability to determine if the book is a bonus point book. The system stores an indication of whether the book is a bonus point book. Processing continues to 206.

At 206, the system determines that the user has successfully completed the quiz for the selected book (e.g., as described above regarding 114). Processing continues to 208.

At 208, the system determines if the selected book is a bonus point book. If so, bonus points (plus standard points) are credited to the user's account (210). If not, standard points are credited (212). It will be appreciated that 202-212 can be repeated in whole or in part in order to accomplish a contemplated reading incentive task.

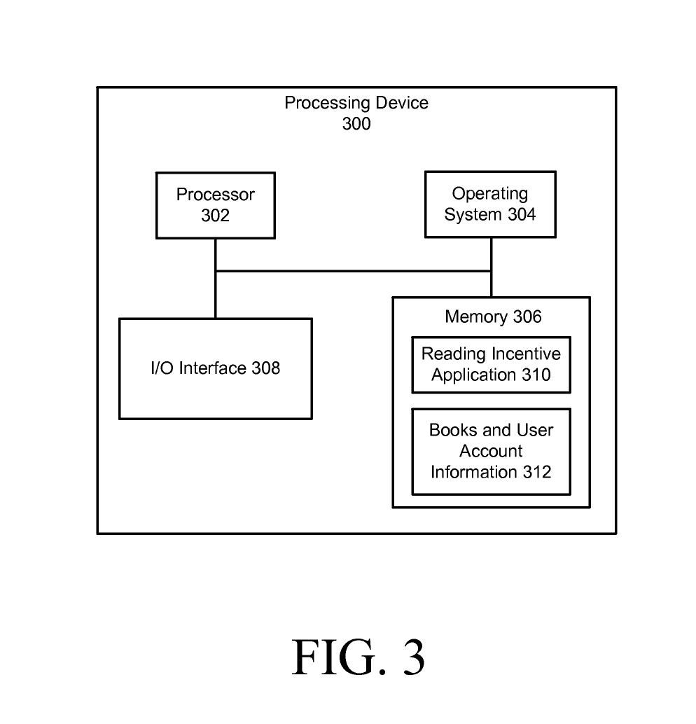

FIG. 3 is an example computer 300 for operating a reading incentive system in accordance with at least one embodiment. The computer 300 includes a processor 302, operating system 304, memory 306 and I/O interface 308. The memory 306 can include a reading incentive system application 310 and one or more electronic books and user accounts 312.

In operation, the processor 302 may execute the application 312 stored in the memory 306. The application 312 can include software instructions that, when executed by the processor, cause the processor to perform operations for a reading incentive system in accordance with the present disclosure (e.g., performing one or more of steps 102-120, 202-212 and/or 402-410 as described above).

The application program 312 can operate in conjunction with the stored books and user accounts 312 and the operating system 304.

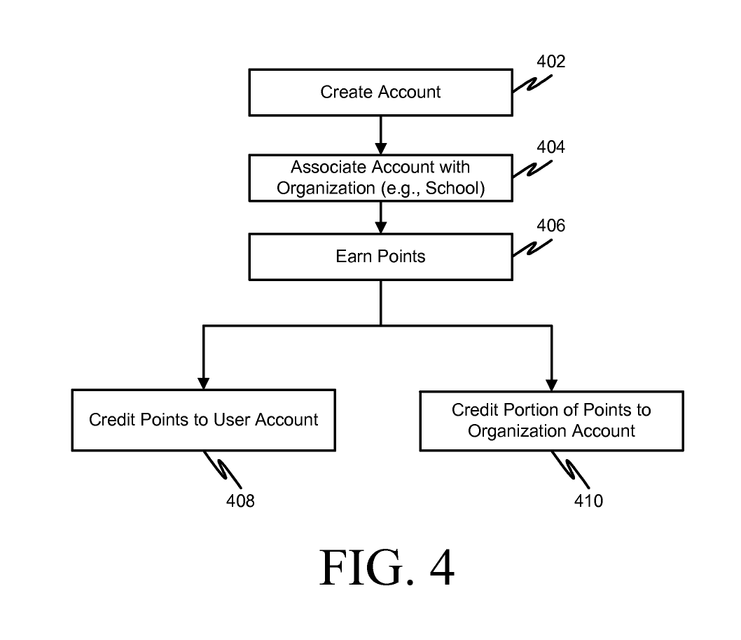

FIG. 4 is a flowchart of an example method for awarding points for reading in accordance with at least one embodiment. Processing begins at 402, where a user account is created (e.g., as described above regarding 102). Processing continues to 404.

At 404, the user can associate an organization (e.g., a school or charity) with the user's account. Processing continues to 406.

At 406, the user earns points for reading books (as described above). Processing continues to 408 and 410.

At 408, points (either bonus or standard) are credited to the user's account. At 410, a portion of points earned by the user are credited to an account associated with the organization that the user selected and associated with at 404. It will be appreciated that 402-410 can be repeated in whole or in part in order to accomplish a contemplated reading incentive task.

In addition to tracking and rewarding the reading progress of individuals, the system can provide a feature that permits user to be joined together in teams (e.g., by class, school, grade, city, state or the like). Some implementations can email or send an electronic message (e.g., an SMS message) to a third party (e.g., a parent of a user, a teacher or the like) when the user completes a book. Some implementations can include a version for adults in which the adults can earn points, such as frequent reader points.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and publishing arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for a reading incentive system.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

1. A computer implemented method comprising:
receiving, at a computer configured to execute a reading incentive application, a book selection from a user;
providing, from the computer, an electronic copy of the book to the user;
starting, at the computer, a first timer;
receiving, at the computer, an indication from the user that the user has completed reading the book within a first time limit as indicated by an elapsed time of the first timer;
generating a quiz having questions related to the book;
presenting the quiz for display to the user, wherein the quiz is based on content from the book and is generated by randomly selecting a predetermined number of questions from a group of questions;
starting a second timer;
receiving answers to the quiz from the user within a second time limit as indicated by an elapsed time of the second timer;
determining if the user passed the quiz, wherein a determination of the user passing the quiz is based on a predetermined percentage of correct answers and completion of the quiz within the second time limit;
if the user passed the quiz, crediting a number of points to an account associated with the user; and
if the user did not pass the quiz, presenting a plurality of user interface elements, wherein one of the user interface elements corresponds to retaking the quiz and another of the user interface elements corresponds to selecting a new book.

2. The method of claim 1, further comprising establishing a new account for the user, the new account including a user profile, authentication credentials and a point balance value.

3. The method of claim 2, further comprising permitting the user to access the reading incentive application when the user supplies credentials matching the authentication credentials in an account.

4. The method of claim 3, further comprising providing a user interface adapted to permit the user to redeem points from the point balance value of the account associated with the user.

5. The method of claim 4, wherein crediting a number of points includes determining if the book is indicated as a bonus point book for the user and, when the book is determined to be a bonus point book, crediting an additional amount of points as a bonus to the point balance value of the account associated with the user.

6. The method of claim 5, further comprising crediting another point value to an account associated with a third party different from the user when the user passes the quiz.

7. A system comprising:
a processor; and
a computer readable medium coupled to the processor, the computer readable medium containing software instructions for a reading incentive application that, when executed by the processor, cause the processor to perform operations including:
receiving a book selection from a user;
providing an electronic copy of the book to the user;
starting a first timer;
receiving an indication from the user that the user has completed reading the book within a first time limit as indicated by an elapsed time of the first timer;
generating a quiz having questions related to the book;
presenting the quiz for display to the user, wherein the quiz is based on content from the book and is generated by randomly selecting a predetermined number of questions from a group of questions;
starting a second timer;
receiving answers to the quiz from the user within a second time limit as indicated by an elapsed time of the second timer;
determining if the user passed the quiz, wherein a determination of the user passing the quiz is based on a predetermined percentage of correct answers and completion of the quiz within the second time limit;
if the user passed the quiz, crediting a number of points to an account associated with the user; and
if the user did not pass the quiz, presenting a plurality of user interface elements, wherein one of the user interface elements corresponds to retaking the quiz and another of the user interface elements corresponds to selecting a new book.

8. The system of claim 7, wherein the operations further comprise establishing a new account for the user, the new account including a user profile, authentication credentials and a point balance value.

9. The system of claim 8, wherein the operations further comprise permitting the user to access the reading incentive application when the user supplies credentials matching the authentication credentials in an account.

10. The system of claim 9, wherein the operations further comprise providing a user interface adapted to permit the user to redeem points from the point balance value of the account associated with the user.

11. The system of claim 10, wherein crediting a number of points includes determining if the book is indicated as a bonus point book for the user and, when the book is determined to be a bonus point book, crediting an additional amount of points as a bonus to the point balance value of the account associated with the user.

12. The system of claim 11, wherein the operations further comprise crediting another point value to an account associated with a third party different from the user when the user passes the quiz.

13. A nontransitory computer readable medium having stored therein software instructions for a reading incentive application that, when executed by a processor, cause the processor to perform operations including:
receiving a book selection from a user;
providing an electronic copy of the book to the user;
starting a first timer;
receiving an indication from the user that the user has completed reading the book within a first time limit as indicated by an elapsed time of the first timer;
generating a quiz having questions related to the book;
presenting the quiz for display to the user, wherein the quiz is based on content from the book and is generated by randomly selecting a predetermined number of questions from a group of questions;
starting a second timer;
receiving answers to the quiz from the user within a second time limit as indicated by an elapsed time of the second timer;
determining if the user passed the quiz, wherein a determination of the user passing the quiz is based on a predetermined percentage of correct answers and completion of the quiz within the second time limit;
if the user passed the quiz, crediting a number of points to an account associated with the user; and
if the user did not pass the quiz, presenting a plurality of user interface elements, wherein one of the user interface elements corresponds to retaking the quiz and another of the user interface elements corresponds to selecting a new book.

14. The nontransitory computer readable medium of claim 13, wherein the operations further comprise establishing a new account for the user, the new account including a user profile, authentication credentials and a point balance value.

15. The nontransitory computer readable medium of claim 14, wherein the operations further comprise permitting the user to access the reading incentive application when the user supplies credentials matching the authentication credentials in an account.

16. The nontransitory computer readable medium of claim 15, wherein the operations further comprise providing a user interface adapted to permit the user to redeem points from the point balance value of the account associated with the user.

17. The nontransitory computer readable medium of claim 16, wherein crediting a number of points includes determining if the book is indicated as a bonus point book for the user and, when the book is determined to be a bonus point book, crediting an additional amount of points as a bonus to the point balance value of the account associated with the user.

18. The nontransitory computer readable medium of claim 17, wherein the operations further comprise crediting another point value to an account associated with a third party different from the user when the user passes the quiz.

19. The method of claim 1, further comprising establishing, at the computer, a warning period in which the user has a predetermined amount of time in which to complete the book after the warning.

20. The method of claim 1, further comprising sending an electronic message to a third party when the user completes the book.
